(19) United States
(12) Patent Application Publication
(10) Pub. No.: US 2018/0192165 A1
(43) Pub. Date: Jul. 5, 2018

(54) METHOD FOR ESTABLISHMENT OF A COMMUNICATION LINK

(71) Applicant: SIEMENS AKTIENGESELLSCHAFT, Munchen (DE)

(72) Inventors: FRANK KOWALEWSKI, Salzgitter (DE); HOLGER SCHMIDT, Braunschweig (DE)

(73) Assignee: SIEMENS AKTIENGESELLSCHAFT, Munchen (DE)

(21) Appl. No.: 15/908,335

(22) Filed: Feb. 28, 2018

Related U.S. Application Data
(63) Continuation of application No. 10/578,708, filed on May 10, 2006.

(30) Foreign Application Priority Data
Nov. 10, 2003 (DE) 10352378.2

(51) Int. Cl. H04Q 3/00

(52) U.S. Cl. CPC H04Q 3/0045; H04Q 3/0025

(57) ABSTRACT

An architecture and a signaling process are created for transmitting call images from a first telecommunication device to a second telecommunication device to establish communication link from the first telecommunication device to the second telecommunication device is established via a telecommunication network. The inventive method is suitable particularly for establishing a connection for call image transmission between SIP supporting telephones and non-SIP supporting telephones.

### CROSS-REFERENCES TO RELATED APPLICATIONS

This application is a continuation of prior filed copending U.S. application Ser. No. 10/578,708, filed May 10, 2006, the priority of which is hereby claimed under 35 U.S.C. § 120 and which is the National Stage of International Application No. PCT/EP2004/052512, filed Oct. 12, 2004, which designated the United States and has been published as International Publication No. WO2005/046161 and which claims the priority of German Patent Application, Serial No. 10352378.2, filed on Nov. 10, 2003, pursuant to 35 U.S.C. 119(a)-(d), the disclosures of which are incorporated herein by reference in their entireties as if fully set forth herein.

### BACKGROUND OF THE INVENTION

### 1. Field of the Invention

The invention relates to a method for the establishment of a communication link from a first telecommunication device to a second telecommunication device via a telecommunication network and more particularly relates to a method whereby, for call signaling in the case of the second telecommunication device, data objects which for example include pictures or tones of the user of the first telecommunication device are played.

### 2. Description of the Related Art

Interpersonal communication by means of telephony, especially mobile telephony, is becoming increasingly important. For such communication, it is in particular important for a telecommunication subscriber, on the establishment of a telephone connection, to know the identity of the calling subscriber before answering or accepting the call. To this end, the called telecommunication subscriber can use different devices for displaying the identification of the calling subscriber, for example, in the form of the name and the telephone number of the calling subscriber. With one such method there is provision for example for a database in the telecommunication device of the called telecommunication subscriber, in the form of an electronic telephone directory in which the telephone numbers and the relevant name, but also a picture relating to the specific name, have been stored. Thus, for a call in which the telephone number of the calling subscriber is transmitted in the usual manner, the telecommunication device of the called subscriber can determine both the associated name and the picture of the calling subscriber in the database and display, in addition, to the telephone number, the name and the picture of the calling subscriber.

The disadvantage of this is that the database which under some circumstances is extensive has to be provided in the telephone of the call recipient and that it has to be provided in each telephone of a call recipient.

A further disadvantage in the case of a procedure in accordance with this method arises from the fact that the calling subscriber has no influence on the picture stored and displayed in the telecommunication device of the call recipient. The settings for displaying and selecting the picture remain the responsibility of the call recipient here, in which case the calling subscriber can neither force the display of a specific picture nor update the displayed picture or also have a current picture displayed to the call recipient.

### SUMMARY OF THE INVENTION

It is thus an aspect of the invention to create a flexible option for establishing a communication link in which the calling subscriber has control over the data objects transmitted during call signaling.

In this case, in accordance with a first aspect of the invention with a method for the establishment of a communication link from a first telecommunication device of a first telecommunication subscriber via a telecommunication network to a second telecommunication device of a second telecommunication subscriber, a connection establishment message is first of all sent to the telecommunication network with a data object allocated to the first telecommunication subscriber in order to initiate the establishment of a communication link, in particular a telephone connection, to the second telecommunication device. Such a data object can for example have multimedia data, which includes a picture file, a tone file and even a text file, etc. Subsequently, the telecommunication network stores the sent data object on a data provision component such as a data server, which is connected to the telecommunication network. Reference information is also determined when the data object is stored, which gives the storage location of the data object, i.e. on which data provision component or in which storage area the data object is stored there in each case. Finally, a transmission of a call signaling message from the telecommunication network to the second telecommunication device is carried out, in which provision has been made for the reference information (determined) in the call signaling message. To this end, the reference information can for example have a “Uniform Resource Identifier” (URI). Because the reference information is now available at the second telecommunication device, the device can now make its own decision on the further procedure. On the one hand, it could decide to accept the call of the calling subscriber (first telecommunication subscriber) without having information about its data object, in particular its picture, and to establish directly a communication link such as a telephone connection. However, it is also possible that the call recipient (second telecommunication subscriber) would readily like to transmit the data object of the calling subscriber to their telecommunication device, in which they in this case signal to the data provision component by using the reference information (i.e. by means of the reference information it is possible to determine on which data provision component or in which storage area there in each case) that the data provision component is to transmit the data object allocated to the first telecommunication subscriber to the second telecommunication device. In response to this signaling process, the data provision component transmits the data object to the second telecommunication device so that the device can receive and play the data object. With regard to a picture or text contained in the data object, the term ‘play’ in this case means that the picture or text is displayed and with respect to tone information or a ring tone stored in the data object means that this is rendered audible by the second telecommunication device. Thus the above-described method makes it possible for both the calling subscriber and the called telecommunication subscriber to have control over the data object provided by the calling subscriber.

If the second telecommunication subscriber has now played the data object of the first telecommunication subscriber, in particular has had their picture displayed, the subscriber can decide to accept the call of the first telecommunication subscriber and establish a communication link or (bidirectional) voice connection to them.

In accordance with an advantageous embodiment, the telecommunication network features a first subnetwork to which the first telecommunication device is allocated and it also features a second telecommunication network to which the second telecommunication device is allocated, in which case the two subnetworks are connected to each other via a switching component, a so-called “gateway”. In particular, the two subnetworks, but also the overall telecommunication network, can be embodied as a mobile radio network, which for example functions in accordance with the GSM (Global System for Mobile Communication) standard or the UMTS (Universal Mobile Telecommunications System) standard. In this case it is possible for the first telecommunication device to be registered in the first subnetwork, while the second telecommunication network is registered the second subnetwork.

In accordance with a further advantageous embodiment, the switching component is embodied so as to implement the above-mentioned operations in the telecommunication network (such as storing the data object and the transmission of a call signaling message). It is further conceivable for the data provision component to be arranged in a network based on an Internet protocol, which is connected to the switching component. It is especially also possible in this case for the data object to be transmitted from the switching component via the “Hyper Text Transfer Protocol” (http) to the data provision component.

It is conceivable that while a connection is being established, the second telecommunication device is in a communication session in accordance with the “Session Initiation Protocol” SIP by means of which interactive multimedia communication sessions can be initiated and controlled. It is in particular possible to initiate telephone conversations with the additional transmission of data objects such as multimedia information. For this purpose, the telecommunication network or the switching component can send a so-called SIP INVITE message as the call signaling message to the second telecommunication device in order to invite it to a communication session. The reference information with respect to the storage location of the data object of the first telecommunication subscriber is also inserted into the INVITE message. Before the actual communication session starts in accordance with the SIP, the data object can now be requested from the second telecommunication device by means of the reference information. Such data transmitted before the actual communication session is also called “early data” or “early media” in connection with the SIP. In this way, it is possible, in accordance with the above-mentioned advantageous embodiment of the method for the establishment of a communication link, also to establish such a communication link between a telecommunication device not supporting the SIP protocol and a telecommunication device supporting the SIP protocol.

In accordance with an advantageous embodiment, the first and/or the second telecommunication device, depending on the nature of the telephone network or the telecommunication subnetwork connected to the device, is embodied with a radio module as a mobile radio device, a mobile telephone or a computer such as a PDA (Personal Digital Assistant) or an organizer.

In addition, a telecommunication arrangement is created which includes a first and a second telecommunication device as well as a telecommunication network. In this arrangement the first telecommunication device is embodied in such a way that it is possible, via the telecommunication network, to establish a communication link, in particular a telephone connection, to the second telecommunication device in accordance with one of the above-described methods.

Furthermore, a method for the establishment of a communication link (in particular a telephone connection) from a first telecommunication device of a first telecommunication subscriber via a telecommunication network to a second telecommunication device of a second telecommunication subscriber is created in accordance with a second aspect of the invention. In accordance with this method, a data object of the first telecommunication subscriber is first of all stored in a data provision component. This can be implemented using many different known types of data transmissions, for example, by sending an e-mail or a message in accordance with the MMS (Multimedia Messaging Service) from the first telecommunication subscriber to the operating company of the data provision component so that it can store a data object stored in the e-mail in the data provision component. The data provision component or its operating company can then return an acknowledgement message to the first telecommunication network which contains reference (information) giving the address of the storage location. In order to initiate the establishment of a communication link, a connection establishment message is now sent together with the reference, which refers to the data object stored in the data provision component, from the first telecommunication device to the telecommunication network. With the aid of the reference information contained in the connection establishment message, the telecommunication network signals to the data provision component that it should transmit the stored data object of the first telecommunication subscriber to the telecommunication network. In response to this signaling process, the data provision component then transmits the data object requested from the telecommunication network to the telecommunication network. Subsequently, the telecommunication network then transmits a call signaling message to the second telecommunication device, in which case provision has been made for the transmitted data object in the call signaling message. The transmitted data object can then be played from the second telecommunication device and in particular, a picture of the first telecommunication subscriber contained in the data object can then be displayed on the second telecommunication device.

After the second telecommunication subscriber, by playing the data object of the first telecommunication subscriber, has now been informed about the fact that the first telecommunication subscriber would like to establish a communication link, the second telecommunication subscriber, by carrying out a corresponding operation (pressing an accept button) on the second telecommunication device, can now accept the call and in this way bring about the establishment of a communication link such as a telephone connection.

Again, in accordance with an advantageous embodiment, the telecommunication network can feature a first subnetwork, which has been allocated to the first telecommunication device, and a second subnetwork, which has been allocated to the second telecommunication device, in which case the two subnetworks are connected with each other via a switching component, namely, a so-called “gateway”. In this case, the first and the second subnetwork, but also the overall telecommunication network can be embodied as a mobile radio network, which for example functions in accordance with the GSM standard or the UMTS standard. Accordingly, it is possible in this case to embody the first and the second telecommunication device as a mobile radio device, a mobile telephone or a computer with a corresponding radio module.

In accordance with an advantageous embodiment, the switching component, namely the gateway, is embodied in this case such that, in order to carry out the above-mentioned procedures in the telecommunication network, in particular signaling the data provision component as well as transmitting the call signaling message to the second telecommunication device. In addition, it is possible to arrange the data provision component in a network based on an Internet protocol, which is connected to the switching component, so that for example a transmission of a data object from the data provision component to the telecommunication network or the switching component can be carried out via an http protocol.

In accordance with an additional advantageous embodiment, the reference information has a Uniform Resource Identifier (URI), which gives the storage location of the data object of the first telecommunication subscriber.

Contrary to the first aspect of the invention, it is possible in the case of the second aspect of the invention that the first telecommunication device is in a communication session in accordance with the SIP, protocol, while the second telecommunication device is not in such a communication session. The network or the switching component thus serves as an interface between a SIP telecommunication device and a non-SIP telecommunication device. Within this context, the first telecommunication device sends a so-called INVITE message to the telecommunication network or the switching component as a connection establishment message, in order to show that a communication link has to be established with the second telecommunication device. In addition, the INVITE message also contains the reference information about the data object stored in the data provision component. After the data provision component has requested the data object and the data object has been sent to the second telecommunication device, the telecommunication network, in particular the switching component can then send a provisional acknowledgement message to the first telecommunication device, which indicates for example by means of ringing that the desired connection establishment is signaled from the second telecommunication device to the second telecommunication subscriber.

In accordance with an embodiment, the data object can contain multimedia contents such as picture information, tone information and even text information.

Furthermore, a telecommunication arrangement is created, which includes a first and a second telecommunication device as well as a telecommunication network. In this case the first telecommunication device has been embodied for that reason to establish, via the telecommunication network, a communication link in particular a telephone connection to the second telecommunication device in accordance with an above-described method according to the second aspect of the invention.

### BRIEF DESCRIPTION OF THE DRAWING

These and other objects and advantages of the present invention will become more apparent and more readily appreciated from the following description of the preferred embodiments, taken in conjunction with the accompanying drawings of which:

FIG. 1 is a block diagram of a telecommunication arrangement for explaining the establishment of a communication link between two telecommunication devices, which are in a communication session in accordance with the SIP protocol;

FIG. 2 is a flowchart of the establishment of a communication link between the telecommunication devices shown in FIG. 1;

FIG. 3 is a block diagram of a telecommunication arrangement in accordance with a first embodiment of the invention for explaining the establishment of a communication link between a telecommunication device supporting the SIP protocol and a telecommunication device not supporting the SIP protocol.

FIG. 4 is a flowchart representing the establishment of a communication link of the telecommunication devices shown in FIG. 3;

FIG. 5 is a block diagram of a telecommunication arrangement in accordance with a second embodiment of the invention for displaying the establishment of a communication link between a telecommunication device not supporting the SIP protocol and a telecommunication device supporting the SIP protocol;

FIG. 6 is a flowchart explaining the establishment of a communication link between the telecommunication devices shown in FIG. 5.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Before two preferred embodiments of the invention are now explained, in which the establishment of a communication link between a telephone supporting the SIP protocol, and a telephone not supporting the SIP protocol is to be carried out, it is indeed necessary to explain the SIP (Session Initiation Protocol) in short.

By using the SIP protocol, it is possible to both initiate and control interactive multimedia communication sessions. It is in particular possible to initiate communication links such as telephone connections or telephone conversations with the additional transmission of multimedia information. In accordance with the SIP protocol, a first subscriber can invite a second subscriber to a meeting or a session with the so-called SIP message INVITE. The second subscriber can then accept the invitation (for the establishment of a communication link such as a telephone conversation) by responding with the so-called SIP message “200-OK”. However, during the period between the arrival of the INVITE message and the acknowledgement of the establishment of the connection or the communication session by means of the “200-OK” message it is already possible to transmit data objects such as multimedia data. Such data is also designated as “early data” or “early media”. The early data can also be picture data or pictures, which have been allocated to the calling subscriber or represent the subscriber. As a result, by means of this above-described method, it is possible to transmit call pictures on the establishment of a communication link within the framework of the SIP protocol.

A special form of transmitting data objects, in particular h picture data, involves transmitting reference information or picture reference information, which refers to the location where the actual contents of the picture has to be found or stored. The SIP protocol also supports the possibility of sending the objects or the contents per reference information instead of transporting the actual data objects or picture contents via the SIP protocol. This mechanism is referred to as the “Content Indirection”.

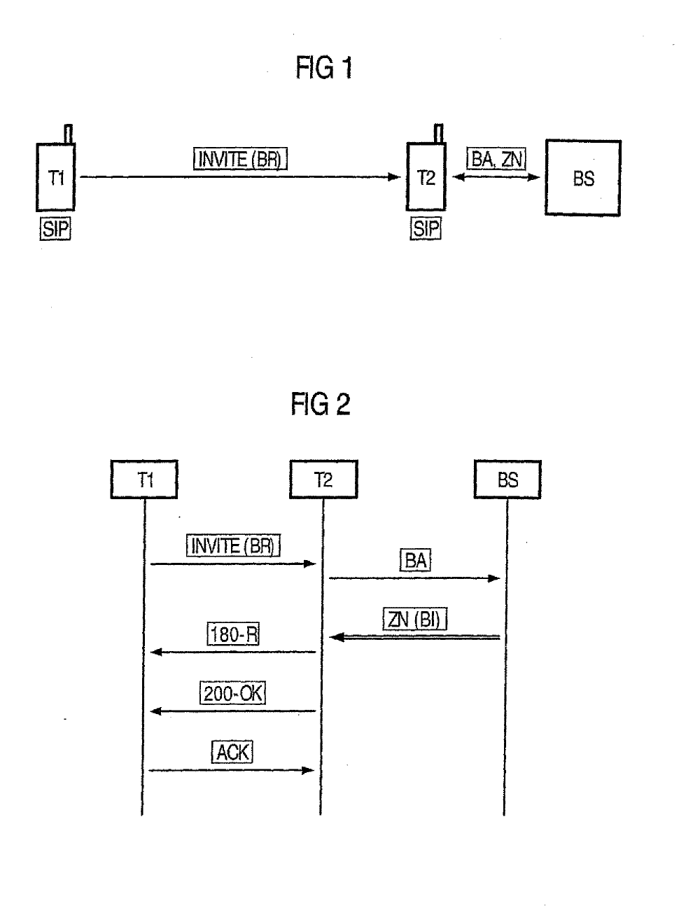

The establishment of a communication link between two telecommunication devices supporting the SIP protocol with the transmission of call pictures will now be explained below. The telecommunication devices involved can for example be mobile telephones. In this case, FIG. 1 represents a block diagram of the most important components on the establishment of the communication link from a first mobile telephone T1 to a second mobile telephone T2, which both support the SIP protocol. In the same way, as will be explained in detail in FIG. 2, a SIP message INVITE, which is transmitted from the calling mobile telephone T1 to the called mobile telephone T2, is now transmitted together with a reference BR on a picture of a telecommunication subscriber allocated to the first mobile telephone T1. By using the reference BR, the second mobile telephone T2 in the connection establishment phase now requests by means of a message BA, the picture content or the actual picture allocated to the reference from a data provision component in this case a picture server BS and by means of a message ZN receives the picture BI which is delivered.

The process described above will now be described and explained in detail with the aid of FIG. 2. As has already been described above, the first mobile telephone T1 invites the second mobile telephone T2 by means of the SIP message INVITE to establish a communication link or to establish a communication session. By means of a so-called “Accept Header”, on transmitting the INVITE message, the first mobile telephone T1 indicates that it supports “Content Indirection”. In addition, with the INVITE message, within the framework of “Early Media”, a reference BR is transmitted to a picture to be displayed on the second mobile telephone. By doing so, the reference includes a so-called SIP-URI (URI: Uniform Resource. Identifier). The URI could for example be as follows: “http:\\www.mysite.org\pictures\portraet.gif”. With the aid of the transmitted reference BR, the second mobile telephone T2 now requests, by means of a picture request message BA, the picture from the data provision component or the picture server BS. In this case, it is assumed that the picture BI is requested per http (Hyper Text Transfer Protocol) from the Web server of the data provision component BS with the Internet address: “www.mysite.org” and is subsequently sent by means of a delivery message ZN to the second mobile telephone T2. As a result, the picture BI is shown on a display (not shown) of the mobile telephone T2, so that the telecommunication subscriber allocated to the second mobile telephone T2 can see the call picture of the first telecommunication subscriber and in this way knows who is making the call. In addition, while the call picture is being displayed, an acoustic signal in the form of a so-called ring tone is output from the second mobile telephone T2, which should also inform the second telecommunication subscriber acoustically that a call is coming in from a first telecommunication subscriber. While the ring tone is being played, the second mobile telephone 12 answers the invite message INVITE with the provisional response 180-R, which indicates that the second mobile telephone is “ringing”.

In this call establishment phase, the telecommunication subscriber of the second mobile telephone T2 can now decide whether or not he/she would like to accept the call of the first subscriber. In the example, the second telecommunication subscriber or the second mobile telephone T2 accepts the call and acknowledges this call with the SIP response 200-OK, which then sends the second mobile telephone to the first mobile telephone. The first mobile telephone T1 now also acknowledges the input of the message 200-OK by means of the message ACK.

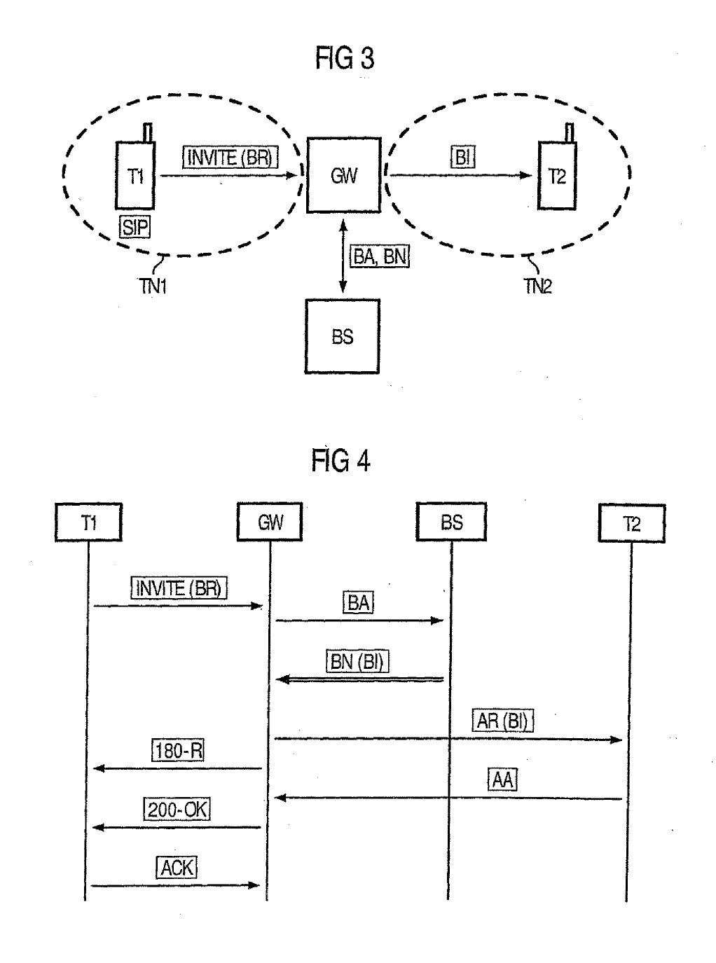

Reference is now made to FIGS. 3 and 4, in which a method for the establishment of a communication link in accordance with a first embodiment of the invention is described. Reference is first of all made in this description to FIG. 3, in which a block diagram of the important components for the establishment of a communication link between two telecommunication devices, in particular the mobile telephones T1 and T2 is shown. In the case, a telephone connection (as a communication link) is now to be established from a first telecommunication device T1 in the form of a mobile telephone via a telecommunication network (represented here by the components GW, TN1, TN2) to a second telecommunication device T2 in the form of a mobile telephone. In this case, the telecommunication network includes two subnetworks, in which case the first subnetwork TN1 is allocated to the first mobile telephone T1 and that the second subnetwork TN2 is allocated to the second mobile telephone T2. Finally, the two subnetworks are connected with each other via a switching component or a “gateway” GW. In addition, the telecommunication arrangement includes according to FIG. 3, a data provision component, here in the form of a picture server BS, which is found in a network based on an Internet protocol and is for example connected via an http protocol to the gateway GW. In addition, it is assumed that the first mobile telephone T1 is in a communication session in accordance with the SIP protocol or supports the SIP protocol, while the second mobile telephone T2 does not support the SIP protocol. In addition, it has also been mentioned that the mobile telephone T2 is not in a position to support the above-mentioned “Content Indirection”, but can in another way for example by means of an instant message or an immediate message (“Instant Message”) be in a position to receive pictures or data objects.

After the components of the telecommunication arrangement have been explained, the sequence for the establishment of a telecommunication link or a telephone connection from the first mobile telephone T1 to the second mobile telephone T2 including the transmission of a call picture should now be explained in accordance with FIG. 4. Reference is made to the fact that the name ‘picture’ or ‘picture data’ has only been selected here as an example and can basically refer to data objects, which in general can include multimedia contents such as ring tones, texts, text files or pictures.

In order to establish a telephone connection, the first mobile telephone T1 now first of all transmits a connection establishment message via the first subnetwork TN1 to the gateway GW. This is done by means of the SIP message INVITE, in which case a corresponding INVITE message is sent from the first mobile telephone to the gateway. However, because the second mobile telephone T2 does not support the SIP protocol, the SIP communication started from the first mobile telephone T1 is not forwarded directly via the telecommunication network to the mobile telephone T2, but is converted by the gateway GW into a corresponding signaling process of the second telecommunication network or telephone network TN2 of T2. Only the converted signaling process is then forwarded to the second mobile telephone T2, while the SIP dialogs are only routed between the first mobile telephone T1 and the gateway GW.

In addition, the INVITE message also sends a picture of the first telecommunication subscriber by means of “Content Indirection” or by means of a reference BR from the first mobile telephone T1 to the second mobile telephone T2. The gateway GW now processes the reference BR in order to be able to request the corresponding picture from the picture server BS by using this reference. This is done by means of the picture request message BA; in response to which the picture server BS, by means of a picture delivery message BN, sends the actual picture or actual picture content BI to the gateway (characterized by means of a double-ended arrow). In this case communication between the gateway GW and the picture server BS is undertaken using http.

Picture BI transmitted from the picture server BS is now transmitted to the second mobile telephone T2 within the framework of a call signaling message AR. It is now possible to display picture BI on a display device of the second mobile telephone T2, while a ring tone is played in order to attract the attention of the second subscriber allocated to the second mobile telephone. While the ring tone is being played, the gateway answers the above-mentioned INVITE message with the provisional response 180-R in order to inform the calling subscriber about the fact that picture BI corresponding to the picture reference BR has been transmitted to the second mobile telephone or that it is “ringing” there in each case.

If the second subscriber decides to accept the call of the first subscriber, the subscriber initiates that a call acceptance message AA is transmitted from the second mobile telephone to the gateway GW in which case the gateway GW translates this call acceptance or acknowledgement in a SIP acknowledgement message 200-OK and sends this message to the first mobile telephone T1. Finally, the first mobile telephone T1 again acknowledges this message 200-OK with the acknowledgement message ACK so that in this case the communication link or the telephone connection between the first mobile telephone and the second mobile telephone is established.

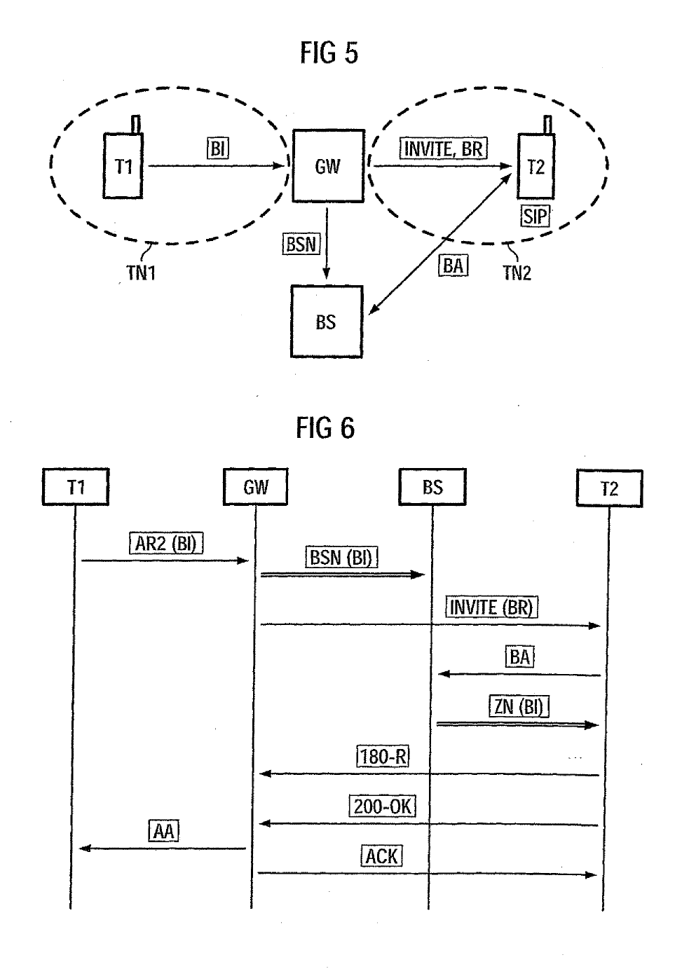

Reference is now made to FIGS. 5 and 6, in which a second embodiment of the invention for the establishment of a communication link or a telephone connection from a first mobile telephone to a second mobile telephone is shown. A characteristic feature of this embodiment is that, contrary to the first embodiment, the first mobile telephone T1 does not support the SIP protocol, while the second mobile telephone T2 supports the SIP protocol. It should once again be mentioned that the first mobile telephone T1 is not in a position to support the above-mentioned “Content Indirection”, but can in another way for example by means of an instant message or an immediate message (“Instant Message”) be in a position to receive pictures or data objects.

Reference is now first of all made to FIG. 5, in which a block diagram is shown with the important components for the establishment of a communication link in accordance with the second embodiment. In this diagram the telecommunication arrangement includes a first telecommunication device in the form of a mobile telephone T1, which would like to establish a communication link or a telephone connection to a second telecommunication device in the form of a mobile telephone T2 via a telecommunication network (represented by the components GW, TN1, TN2). In the case—in the same way as is already the case in a first embodiment—the telecommunication network should have two subnetworks, in which case the first mobile telephone T1 is allocated to the first subnetwork TN1 and the second mobile telephone T2 to the second subnetwork TN2. The two subnetworks are finally connected with each other via a switching component, namely a gateway GW. In addition, the gateway is connected to a data provision component or a picture server BS on which data objects, more particularly, pictures have extensively been stored. The signaling process between the individual components for the establishment of a communication link should now be explained in detail based on FIG. 6.

In accordance with FIG. 6, for the establishment of a communication link or a telephone connection from the first mobile telephone T1 to the second mobile telephone T2, a connection establishment message AR2 is first of all sent from the first mobile telephone T1 to the gateway GW. This means that—in the same way as is the case for the first embodiment—the communication is not forwarded directly from the first subnetwork TN1, which has been allocated to the first mobile telephone, directly to the second subnetwork TN2, which has been allocated to the second mobile telephone, but that the gateway GW rather serves as an interface and converts the signaling process of the first subnetwork into a SIP-signaling process for the second subnetwork. SIP dialogs are then only routed between the gateway GW and the second subnetwork or the second mobile telephone. This now means that after receipt of the connection establishment message AR2, which also contains a picture BI of the telecommunication subscriber allocated to the first mobile telephone, the gateway converts the picture into a SIP context or a SIP signaling process by sending the picture or the picture content BI to the picture server BS by means of a picture storage message BSN. Once again the picture server can be in a network based on an Internet protocol, in which case the picture server BS is connected to the gateway GW via an http protocol. In this way, it is possible to send the picture BI per http to the picture server and deposited or stored there in each case. If the picture has been stored in the picture server, the gateway GW invites the second mobile telephone T2, by means of an INVITE message, to a communication session, i.e. the INVITE message represents a call signaling message, which signals to the second mobile telephone T2, that a first subscriber or its allocated first mobile telephone T1 would like to establish a communication link or a telephone connection. In addition, a picture reference BR is also inserted in the INVITE message, the reference giving the location where the picture BI associated with the picture reference has been stored (here, in the same way as the above-mentioned for a picture server BS). In accordance with an advantageous embodiment it is in this case also possible, that already at this point in time, i.e. after the arrival of the INVITE message, an acoustic signal for example in the form of a ring tone can be output from the second mobile telephone to the subscriber allocated to the second mobile telephone T2, the ring tone referring to the incoming call.

Next, the second mobile telephone T2, by means of a picture request message BA and by using the picture reference BR, now requests the picture from the picture server BS allocated to the picture reference. In response to the picture request message BA, the picture server BS transmits, by means of a delivery message ZN, the picture BI allocated to the picture reference, to the second mobile telephone T2. In this way, the picture of the first telecommunication subscriber can be displayed as a call picture to the second telecommunication subscriber by the second mobile telephone. As has already been mentioned, an acoustic signal such as a ring tone can be played either directly after the arrival of the INVITE message at the second mobile telephone or after the arrival of the delivery message ZN with the picture BI. Irrespective of the fact when the acoustic signal is output from the second mobile telephone, i.e. when it “rings” at the second mobile telephone, a provisional response 180-R is sent from the second mobile telephone T2 to the gateway GW (as acknowledgement for the fact that the second mobile telephone has received the call signaling and that the second subscriber has for example been informed by means of an acoustic signal).

After the second subscriber has been informed about the call of the first subscriber, the subscriber can either accept or reject the call. Should the subscriber decide to accept the call, the subscriber will inform the second mobile telephone T2 via a corresponding user interface, whereupon the second mobile telephone T2 sends a call acceptance message 200-OK to the gateway. Finally, this (positive) response is converted by the gateway GW into an acknowledgement, which is then routed in the form of an acceptance information message AA to the first mobile telephone T1. Furthermore, the gateway GW also acknowledges the call acceptance message 200-OK of the second mobile telephone and then also routes an acknowledgement message in the form of the message ACK to the telephone in each case. In this way, a communication link or a telephone connection is then established between the first mobile telephone T1 and the second mobile telephone T2.

It should be mentioned that the telecommunication network connecting the two mobile telephones T1 and T2, in particular the two subnetworks allocated to the mobile telephones can function for example in accordance with the GSM (Global System for Mobile Communication) standard or the UMTS (Universal Mobile Telecommunications System) standard.

In addition it should be mentioned that in accordance with an advantageous embodiment, in particular, in the case of the embodiment shown in FIGS. 5 and 6, a picture does not necessarily have to stored in the first mobile telephone (in the mobile telephone of the calling subscriber) and sent with a connection establishment message to the telecommunication network or the gateway GW, but a call picture allocated to a calling subscriber or a first subscriber could also already have been stored in the telecommunication network in this case for example in the HLR (Home Location Register), should it be a mobile radio network, and it can be transmitted from there via the gateway GW to a picture server for a call or the establishment of a communication link. This relieves the load on the air interface between the first mobile telephone T1 and the telecommunication network for example in each case.

With the above-described mechanisms it is not only possible to transmit pictures (or general data objects) from the calling subscriber to the called subscriber, but also pictures from the called subscriber to the calling subscriber or its mobile telephone, or as has just been explained, from the telecommunication network to the calling subscriber. In this case, the transmission of pictures or data objects from the called subscriber to the calling subscriber can be carried out together with one of the above-mentioned methods or as a standalone method. This means in one case (in which the calling subscriber supports a method such as for example SIP and the called subscriber does not support it) the called subscriber, in response to a call signaling message of a calling subscriber, can send a data object as a message to the telecommunication network allocated to the subscriber, in which case the data object is then stored by the telecommunication network on a data provision component. In addition, a response message (connection establishment message) is transmitted from the telecommunication network to the calling subscriber, with provision being made in the response message for reference information which refers to the data provision component on which the data object of the caned subscriber has been stored. Finally, the data provision component is signaled from the calling subscriber or its telecommunication device, using the reference information, that the data provision component transmits the data object to the second telecommunication device allocated to the called subscriber. Subsequently the data object is transmitted from the data provision component to the calling subscriber and played or (should it be a picture) displayed there in each case. On the other hand, (in which the called subscriber supports a method such as for example SIP and the calling subscriber does not support it), the called subscriber can store a data object on a data provision component. In response to the call signaling message from the telecommunication network, the called subscriber or its telecommunication device sends a message with the picture reference information, which refers to the data object stored by the subscriber in the data provision component, to the telecommunication network. The network signals to the data provision component, using the reference information, that the data provision component transmits the stored data object to the telecommunication network. Subsequently, the data provision component transmits the data object to the telecommunication network. Finally, a response message is transmitted from the telecommunication network to the calling subscriber, with there being provision in this message for the transmitted data object of the called subscriber. The transmitted data object can then be played or displayed at the calling subscriber.

Therefore, to summarize it is possible to say that the fundamental idea of the two embodiments represented in FIGS. 3 to 6 is creating an architecture and a signaling process for transmitting call pictures, which are in a known manner transmitted from telephones supporting the SIP protocol per “Content Indirection”. The method is suitable particularly for establishing a connection for call picture transmission between SIP-supporting telephones and non-SIP supporting telephones. This means that the SIP telephone sends a reference to the picture instead of the contents of a call picture of a SIP-supporting telephone. If the receiver does not support the SIP protocol, the picture is loaded according to the reference and transmitted from the telecommunication network (in particular a gateway) to the receiver telephone. Conversely, the call picture of a non-SIP supporting calling telephone is stored in a telecommunication network and a reference to the stored picture is then sent to the called SIP-supporting telephone. By doing so, it is then in particular advantageous for a SIP-supporting telephone that the telephone does not have to transmit the actual picture contents, and indeed also not in cases when the SIP-supporting telephone sends the picture (in the form of a reference). As a result, fewer transmission resources are required. In addition, a very flexible option for picture provision is granted. Pictures can be provided according to all forms of supported URIs (for example, the pictures can be provided per http).

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for the establishment of a communication link from a first telecommunication device of a first telecommunication subscriber to a second telecommunication device of a second telecommunication subscriber via a telecommunication network, comprising the following steps:
storing a data object on a data provision component;
sending a connection establishment message together with picture reference information, which refers to the data object stored on the data provision component, from the first telecommunication device to the telecommunication network;
signaling the data provision component from the telecommunication network by using the reference information that the data provision component transmits the stored data object to the telecommunication network;
transmitting the data object from the data provision component to the telecommunication network;
transmitting a call signaling message from the telecommunication network to the second telecommunication device, wherein the call signaling message provides the transmitted data object; and
playing the transmitted data object at the second telecommunication device.

2. The method of claim 1, wherein the telecommunication network has a first subnetwork which has been allocated to the first telecommunication device and a second subnetwork which has been allocated to the second telecommunication device, wherein the first subnetwork and second subnetwork are connected to each other via a switching component.

3. The method of claim 2, wherein the switching component is configured to carry out the steps of the signaling and transmitting processes.

4. The method of claim 2, wherein the data provision component is arranged in a network based on an Internet protocol, which is connected to the switching component.

5. The method of claim 1, wherein the reference information has a Uniform Resource Identifier (URI).

6. The method of claim 1, wherein the first telecommunication device is in a communication session in accordance with the Session Initiation Protocol (SIP).

7. The method of claim 1, wherein the first telecommunication device, as the connection establishment message, sends an INVITE message to the telecommunication network into which the reference information has been inserted.

8. The method of claim 1, wherein the data object includes picture information, tone information and text information.

9. The method of claim 1, wherein the first and/or second telecommunication device is embodied as a mobile radio device, a mobile telephone or a computer with a radio module.

10. The method of claim 1, wherein the telecommunication network includes a mobile radio network which in particular functions according to the Global System for Mobile Communication (GSM) standard or the Universal Mobile Telecommunications System (UMTS) standard.

11. A telecommunication arrangement including a first telecommunication device and a second telecommunication device as well as a telecommunication network and a data provision component connected to it, wherein the first telecommunication device arrangement is configured to:
establish a communication link to the second telecommunication device via the telecommunication network;
store a data object on the data provision component;
send a connection establishment message together with picture reference information, which refers to the data object stored on the data provision component, from the first telecommunication device to the telecommunication network;
signal the data provision component from the telecommunication network by using the reference information that the data provision component transmits the stored data object to the telecommunication network;
transmit the data object from the data provision component to the telecommunication network;
transmit a call signaling message from the telecommunication network to the second telecommunication device, wherein the call signaling message provides the transmitted data object; and
play the transmitted data object at the second telecommunication device.

12. A method for establishment of a communication link from a first telecommunication device of a first telecommunications subscriber to a second telecommunication device via a telecommunication network, comprising:
sending a connection establishment message with a data object allocated to a first subscriber to the telecommunication network to establish the communication link;
storing the data object via the telecommunication network on a data provision component;
transmitting a call signaling message from the telecommunication network to the second telecommunication device providing reference information which refers to the data provision component on which the data object of the first subscriber has been stored;
signaling the data provision component from the second telecommunication device by using the reference information requesting that the data provision component transmit the data object to the second telecommunication device allocated to the first subscriber;
transmitting the data object from the data provision component to the second telecommunication device; and
playing the data object at the second telecommunication device.

13. The method according to claim 12, wherein the telecommunication network has a first subnetwork to which the first telecommunication device has been allocated and a second subnetwork to which the second telecommunication device has been allocated, the first and second subnetworks being connected with each other via a switching component.

14. The method according to claim 13, wherein the switching component performs said storing and transmitting.

15. The method according to claim 14, wherein the data provision component is arranged on a network based on an Internet protocol and connected to the switching component.

16. The method according to claim 15, wherein the reference information has a uniform resource identifier.

17. The method according to claim 16, wherein the second telecommunication device is in a communication session in accordance with a session initiation protocol.

18. The method according to claim 17, wherein the switching component, as a call signaling message, sends an INVITE message to the second telecommunication device into which the reference information has been inserted.

19. The method according to claim 18, wherein the data object includes picture information, tone information and text information.

20. The method according to claim 19, wherein at least one of the first and second telecommunication devices is one of a mobile radio device, a mobile telephone and a computer with a radio module.

21. The method according to claim 20, wherein the telecommunication network includes a mobile radio network functioning according to one of a global system for mobile communication standard and a universal mobile telecommunications system standard.

22. A telecommunication system, comprising: a telecommunication network; a data provision component, connected to said telecommunication network; and first and second telecommunication devices, said first telecommunication device establishing a communication link to said second telecommunication device via said telecommunication network by sending a connection establishment message with a data object to said telecommunication network allocated to a first subscriber to establish the communication link, said data provision component storing the data object, said telecommunication network transmitting a call signaling message to said second telecommunication device providing reference information which refers to the data provision component on which the data object of the first subscriber has been stored, said second telecommunication device signaling said data provision component using the reference information to request that said data provision component transmit the data object to said second telecommunication device allocated to the first subscriber, said data provision component transmitting the data object to said second telecommunication device and said second telecommunication device playing the data object.
